(19) United States
(12) Patent Application Publication
(10) Pub. No.: US 2026/0089067 A1
(43) Pub. Date: Mar. 26, 2026

(54) OPERATION PREDICTIONS IN WIRELESS COMMUNICATION NETWORKS

(71) Applicant: Telefonaktiebolaget LM Ericsson (publ), Stockholm (SE)

(72) Inventors: Praveen KUMAR, Jharkhand (IN); Rashmi TOMER, New Delhi (IN); Vivek KUMAR, Bulandshahr/UP (IN); Ajay SHARMA, Karnataka (IN); Gaurav KAROLIWAL, Jaipur (IN)

(21) Appl. No.: 19/102,558

(22) PCT Filed: Apr. 6, 2023
(86) PCT No.: PCT/IN2023/050336

§ 371 Date: Feb. 10, 2025

(30) Foreign Application Priority Data
Aug. 12, 2022 (IN) 202211046111

(51) Int. Cl. H04L 41/147; H04W 24/02

(52) U.S. Cl. CPC H04L 41/147; H04W 24/02

(57) ABSTRACT

A method of managing a wireless communication network includes obtaining data regarding performance of a cell of the wireless communication network, and generating, based on the obtained data, predictions of values of a plurality of key performance indicators (KPIs) of the cell of the wireless communication network that are correlated with uplink (UL) throughput. The method includes generating a prediction that the cell will experience degraded UL throughput at a future time based on the predicted values of the KPIs, and determining, from among the plurality of KPIs, a set of candidate root cause KPIs associated with the predicted degraded UL throughput. The method further includes selecting an actuation based on the determined set of candidate KPIs, and applying the actuation to the wireless communication network.

### TECHNICAL FIELD

The present disclosure relates generally to network management of wireless communication networks, and in particular to systems and methods for predicting uplink (UL) throughput with proactive healing in fifth generation (5G) networks.

### BACKGROUND

With large-scale commercialization of 5G networks, operators may increasingly turn more of their attention to opportunities in business-to-business markets. A quality 5G network should accommodate massive data capacity requirements for uplink (UL) data transmission to support high-definition video, online games, big data collection, intelligent surveillance, alternate reality/virtual reality, live video, and other uplink data-intensive services. The increasing demands on uplink data transfer requires continuous improvement of network capacity and throughput.

5G implementations may be Non-Stand Alone (NSA) implementations that interwork with non-5G network elements, or Stand Alone (SA) implementations that only include 5G network elements. Moreover, 5G networks may involve multi-radio access technology (RAT) components, especially in the NSA architecture. In addition to the architecture, dynamic spectrum sharing allows instantaneous sharing of spectral resources between fourth generation (4G) and 5G in NSA implementations. Spectral sharing is illustrated in FIG. 1. As shown in FIG. 1, a wireless communication network, such as a 4G network, can occupy an entire 20 MHz bandwidth for example. Alternatively, the 4G network may share the 20 MHz bandwidth with a 5G network, with each network occupying a separate 10 MHz bandwidth, or both networks can share the same 20 MHz bandwidth using dynamic spectrum sharing (DSS).

Because of increased demand for UL data transfer in 5G networks, it is important for 5G network operators to be able to ensure that adequate UL resources are available to users.

Some efforts have been made to predict UL throughput in communications networks using machine learning. However, previous efforts have not addressed the management of UL throughput in a multi-RAT environment presented by 5G NSA or SA architecture implementations, or the spectrum sharing components that are introduced in 5G technology. Moreover, many ML solutions are not proactive ML solutions, but rather are predictive in nature.

### SUMMARY

Some embodiments provide a method of managing a wireless communication network including obtaining data regarding performance of a cell of the wireless communication network, and generating, based on the obtained data, predictions of values of a plurality of key performance indicators (KPIs) of the cell of the wireless communication network that are correlated with uplink (UL) throughput. The method includes generating a prediction that the cell will experience degraded UL throughput at a future time based on the predicted values of the KPIs, and determining, from among the plurality of KPIs, a set of candidate root cause KPIs associated with the predicted degraded UL throughput. The method further includes selecting an actuation based on the determined set of candidate KPIs, and applying the actuation to the wireless communication network.

The data regarding performance of the cell may include performance measurement data and/or configuration management data.

Predicting the value of the KPIs may include generating features for a machine learning, ML, model based on the data regarding performance of the cell.

Generating the features may include generating moving averages of the KPIs over one or more past time periods.

Generating the features may include generating lagged values of the KPIs from past time periods.

The method may further include generating threshold values for the KPIs based on historical values of the KPIs. Generating the prediction that the cell will experience degraded uplink throughput may be based on a comparison of predicted values of the KPIs with the threshold values of the KPIs.

The threshold values for the KPIs may be obtained through exploratory data analysis of historical data from the wireless communication network. In some embodiments, the threshold values of the KPIs may be obtained based on an operating frequency band and bandwidth of the wireless communication network.

The method may further include categorizing the KPIs into a plurality of KPI categories, selecting the ML model from among a plurality of ML models based on the categorization of at least one of the KPIs, and applying the ML model to generate the prediction of the value of the at least one of the KPIs.

The method may further include selecting a plurality of ML models based on the categorizations of the KPIs, and applying the plurality of ML models.

The KPIs may be categorized as relating to availability, accessibility, retainability, mobility, coverage, quality, utilization, transport ratio and/or accessibility of the cell.

The ML model may include a plurality of ML models, and the prediction that the cell will experience degraded UL throughput is based on the output of the plurality of models.

The prediction that the cell will experience degraded UL throughput may be based on a weighted average of the output of the plurality of models.

The plurality of ML models may include one or more of an XGBoost model, a Random Forest model, a long short-term memory model, a CatBoost model and a light gradient boosting model.

Determining the set of candidate root cause KPIs may include generating a ranking of the plurality of KPIs based on importance to the predicted UL throughput degradation, and selecting the set of candidate root cause KPIs based on the ranking of KPIs by importance.

The ranking of the plurality of KPIs may be generated by applying a Tree Shapley Additive Explanations (Tree SHAP) algorithm to the KPI and UL throughput degradation predictions.

The method may further include categorizing each candidate root cause KPI of the set of candidate root cause KPIs into one of a plurality of KPI categories. The actuation may be selected based on KPI categories of the set of candidate root cause KPIs.

Selecting the actuation may include determining if at least one of the set of candidate root cause KPIs are categorized according a first KPI category, upon determining that at least one of the set of candidate root cause KPIs is categorized according the first KPI category, checking an operating condition of the wireless communication network associated with the first KPI category, and selecting the actuation based on the operating condition of the wireless communication network associated with the first KPI category.

The method may further include repeating, for a plurality of KPI categories, steps of determining if at least one of the set of candidate root cause KPIs are categorized according a KPI category, checking an operating condition of the wireless communication network associated with the KPI category, and selecting the actuation based on the operating condition of the wireless communication network associated with the KPI category.

Some embodiments provide a network management system including a processor, and a memory coupled to the processor. The memory includes computer program instructions that, when executed by the processor, cause the network management system to perform operations including obtaining data regarding performance of a cell of the wireless communication network, generating, based on the obtained data, predictions of values of a plurality of KPIs of the cell of the wireless communication network that are correlated with UL throughput, generating a prediction that the cell will experience degraded UL throughput at a future time based on the predicted values of the KPIs, determining, from among the plurality of KPIs, a set of candidate root cause KPIs associated with the predicted degraded UL throughput, selecting an actuation based on the determined set of candidate KPIs, and applying the actuation to the wireless communication network.

Some embodiments provide a computer program comprising computer code to be executed by a network management system configured to perform operations including obtaining data regarding performance of a cell of the wireless communication network, generating, based on the obtained data, predictions of values of a plurality of KPIs of the cell of the wireless communication network that are correlated with UL throughput, generating a prediction that the cell will experience degraded UL throughput at a future time based on the predicted values of the KPIs, determining, from among the plurality of KPIs, a set of candidate root cause KPIs associated with the predicted degraded UL throughput, selecting an actuation based on the determined set of candidate KPIs, and applying the actuation to the wireless communication network.

Some embodiments provide a computer program product comprising a non-transitory storage medium including program code to be executed by processing circuitry of a network management system, whereby execution of the program code causes the device to perform operations including obtaining data regarding performance of a cell of the wireless communication network, generating, based on the obtained data, predictions of values of a plurality of KPIs of the cell of the wireless communication network that are correlated with UL throughput, generating a prediction that the cell will experience degraded UL throughput at a future time based on the predicted values of the KPIs, determining, from among the plurality of KPIs, a set of candidate root cause KPIs associated with the predicted degraded UL throughput, selecting an actuation based on the determined set of candidate KPIs, and applying the actuation to the wireless communication network.

Some embodiments described herein may provide certain advantages. For example, they may enable proactive identification and correction of UL throughput issues before they occur. By predicting UL throughput issues in advance, the network may have adequate time to implement actuations to prevent degradation. This may provide an improved customer experience with services that require high UL throughput, such as video conferencing, video gaming, virtual reality applications, etc. Some embodiments may increase the performance of cells in a wireless communications network, which can improve the quality of service and optimize utilization of network resources. Moreover, some embodiments may be scalable with network size, geography and complexity, and may apply to SA and NSA architectures.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates spectral sharing in a wireless communication system.

FIG. 2 illustrates operations for predicting low UL throughput and self-healing of cell according to some embodiments.

FIG. 3 illustrates operations of systems/methods according to some embodiments.

FIG. 4 illustrates a cell labelling operation according to some embodiments.

FIG. 5 illustrates an example of a ranking of key performance indicators (KPIs) that may be output by a root cause mapping operation according to some embodiments.

FIG. 6 illustrates an example operation of actuation selection based on a root cause identification operation according to some embodiments.

FIG. 7 illustrates self-healing operations by a network management system according to some embodiments.

FIG. 8 is a block diagram of a network management system in accordance with some embodiments.

FIG. 9 is a flowchart illustrating operations of a network management system in accordance with some embodiments.

FIG. 10 is a block diagram of a communication system in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The following explanation of potential problems with some approaches is a present realization as part of the present disclosure and is not to be construed as previously known by others.

Some embodiments described herein utilize Machine Learning (ML) concepts to predict in advance which cells of a wireless communication network may suffer symptoms of low UL throughput. Further, some embodiments may select actuations that may be applied to the network, before the cells suffer the predicted UL degradation. The selection of actuations to be applied to the network may be based on an analysis of the factors that contributed to the prediction of UL degradation. The selection and application of actuations based on predicted UL throughput degradation is referred to herein as “self-healing.” However, it will be understood that systems and/or methods as described herein may avert UL throughput degradation before it happens.

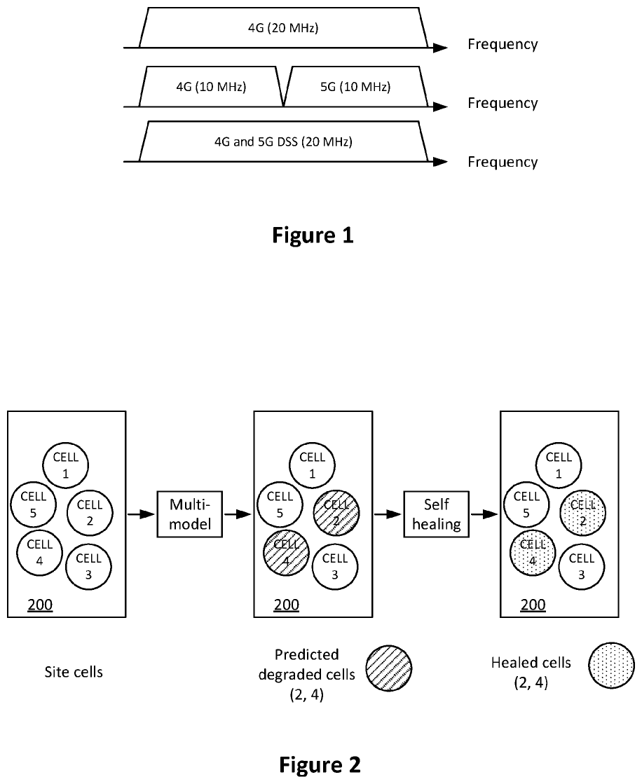

FIG. 2 is a general overview of operations for predicting low UL throughput and self-healing of cell according to some embodiments. As shown in FIG. 2, a wireless communication network 200 may include a plurality of cells in which wireless communication devices may obtain service.

Secondary key performance indicators (KPIs) are KPIs that may contribute to a primary KPI of interest, such as UL throughput. Secondary KPIs may be defined by standards such as the New Radio (NR) standard. Secondary KPIs which may be taken into consideration include quantities such as UL received signal strength indicator (RSSI), block error rate (BLER), channel quality indicator (CQI), signal to interference plus noise ratio (SINR), reference signal received power (RSRP), rank indictor, path loss, packet loss, dual connectivity setup scheduling requests (SR), modulation KPIs, resource block (RB) symbol utilization, user number, availability, etc.

Secondary KPIs may be categorized as belonging to categories such as accessibility, retainability, mobility, integrity, availability, and quality. Secondary KPIs may be measured for each cell, and the measured KPI data may be processed by an ensemble ML algorithm as described in more detail below to predict which cells are likely to suffer degraded UL throughput at a future time, e.g., two hours in advance. In the example shown in FIG. 2, cell 2 and cell 4 are predicted to suffer degradation within two hours based on the analysis of KPI measurements.

In a self-healing process, one or more actuations may be chosen based on the KPIs that were important to the UL degradation prediction, and the actuations are applied to the network. The actuations may include actions that may be taken automatically or by a network operator to change the operation of the network, and are selected to avert the predicted UL throughput degradation. The actuations may include actions such as optimizing network parameters, optimizing thresholds, checking various network conditions, etc. The systems/methods continue to monitor the KPIs to ensure that KPI degradation does not occur. As shown in FIG. 2, after application of the actuation(s), cells 2 and 4 are considered “healed” (although they may have never actually experienced the predicted UL throughput degradation).

In some embodiments, a ML algorithm is trained on secondary KPIs to identify in advance cells which may show UL throughput degradation issue in the future (e.g., within several hours).

The ML algorithm uses Performance Management (PM) counters and Configuration Management (CM) Data to study the cell behavior under different conditions. An ensemble algorithm correlates the performance of important KPIs in past hours with the cell's behavior in future.

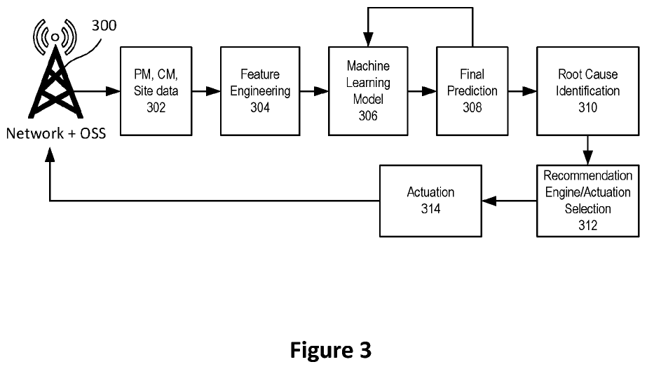

FIG. 3 illustrates operations of systems/methods according to embodiments described herein. Referring to FIG. 3, at block 302, a network management system according to some embodiments collects data relating to a wireless communication network 300. In particular, data may be collected from an Operations Support System (OSS) of the network 300. The collected data may include performance management (PM) data, configuration management (CM) data and/or data about the operation of particular sites or nodes within the network. The data may include PM Counters, CM counters. Cell/Site Database and/or other information.

At block 304, the systems/methods perform feature engineering to generate, from the collected data, a set of features that can be input into a ML model to generate a prediction of UL throughput degradation for a given cell of the network. Feature engineering involves developing an appropriate relation between the key counters collected in the data collection process. In a wireless communication network, values of KPIs have temporal dependencies. That is, the future values of KPIs are statistically related to and dependent upon past values of the KPIs. For that reason, time dependent features, such as averages and lags of KPI values, may be chosen as some of the features to be input to the ML model.

The inventors have found that there is a good correlation between lag values (e.g., 15 minute and 30 minute lag values) and moving average values of KPIs that relate to UL throughput in a wireless communication network. For example, moving averages of KPIs calculated over a past number of hours, past day, and past week may provide insights about impending cell behavior.

“Lagging” a time series means to shift its values forward one or more time steps, or equivalently, to shift the times in its index backward one or more steps. For example, Table 1 shows a variable “y” along with lagged values “y_lag_1” and “y_lag_2” that are lagged by one and two time steps, respectively (in this example, months).

TABLE 1
Example of Data Lagging

| Date | y | y_lag_1 | y_lag_2 |
|---|---|---|---|
| 1954-Jul. | 5.8 | NaN | NaN |
| 1954-Aug. | 6.0 | 5.8 | NaN |
| 1954-Sep. | 6.1 | 6.0 | 5.8 |
| 1954-Oct. | 5.7 | 6.1 | 6.0 |
| 1954-Nov. | 5.3 | 5.7 | 6.1 |

In Table 1, column “y” is taken as reference and lagged values are generated by shifting the values by one and two time steps.

Lagged values of primary and secondary KPIs may help to provide accurate UL throughput predictions. For example, the following formula may help predict uplink throughput based on performance measurement (PM) KPIs relating to information about UL data volume in the MAC entity (mac-volume) and PUSCH scheduled activity (pusch-sched-activity):

Uplink throughput=(64*(mac-volume/(pusch-sched-activity*1000)))

A combination of band and bandwidth from the cell definition may be used to determine dynamic threshold settings for the target label of UL throughput degradation.

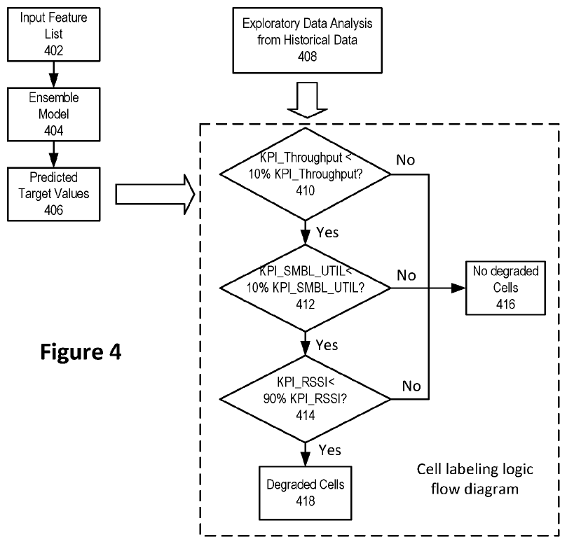

Once the relevant features have been defined, the feature data is processed by a ML model 306, which generates a prediction of UL degradation for a cell. In particular, the ML model may be a classification model that labels a cell as degraded or not degraded based on analysis of the relevant features. In particular, the ML model may be a regression model that predicts a UL throughput value for a cell, which then can be labelled if degraded as illustrated in FIG. 4 and described below.

In some embodiments, the ML model 306 may be an ensemble ML model that combines the outputs of several different ML algorithms. For example, the outputs of the different ML algorithms may be combined as a weighted average, and the labeling of the cell may be based on the combined output of the ML algorithms. This approach is based on a finding that different features may provide different levels of predictive performance for UL throughput degradation when processed by different models.

Accordingly, some embodiments use different classification algorithms trained on specific features. Some algorithms considered include XGBoost, CatBoost Random Forest, Long short-term memory (LSTM), and Light Gradient Boosting Machine (LightGBM).

The ensemble ML algorithm is based on the hypothesis that UL throughput degradation occurs when there is degradation in following categories of KPIs:
Availability
Accessibility (ENDC Setup SR)
Retainability
Mobility (Change SR)
Coverage & Quality (RSRP/UL RSSI/BLER/CQI/RANK/SINR/Path Loss)
Utilization (Payload/User Number/RB Symbol Utilization/RRC Connected & Active Users
Transport Ratio
Integrity (Packet Loss)

To obtain a single prediction based on these different types of features, different ML models may be used, and the outputs of the different models may be combined, for example as a weighted average, to provide a final prediction of future cell classification as degraded or non-degraded in terms of UL throughput.

The performance in terms of prediction accuracy for UL throughput degradation of several different models including Random Forest, CatBoost and Long Short-Term Memory (LSTM) was measured. The results are shown in Table 2 along with the results for an aggregated model that combined the outputs of different models as described above. As seen in Table 2, the aggregated model performed better than any individual model in each of the R2, root mean square error (RMSE), Precision, F1 score and Recall metrics.

TABLE 2
Comparison of Metrics for Different ML Models

| | Random | | | |
|---|---|---|---|---|
| Metric | Forest | Catboost | LSTM | Aggregated |
| R2 | 0.65 | 0.73 | 0.72 | 0.82 |
| RMSE | 0.356 | 0.67 | 0.14 | 0.01 |
| Precision | 81.56 | 81.71 | 86.56 | 85.56 |
| F1 Score | 85.63 | 82.63 | 88.93 | 92.93 |
| Recall | 75.60 | 65.74 | 80.76 | 86.76 |

Some systems/methods generate a prediction of cell degradation two hours in the future. Two hours was chosen as a target future time for the prediction, because it has been found that it is difficult to obtain an accurate prediction of UL throughput degradation based on KPI analysis for a time period greater than two hours, but relatively accurate predictions of UL throughput degradation within two hours can be obtained. Also, advance knowledge of UL throughput degradation that may occur two hours hence provides enough time to implement an actuation on the network that can help to prevent the predicted UL throughput degradation from happening. However, it will be appreciated that other time lags, including time lags greater than two hours and time lags less than two hours, may be used for the prediction depending on the nature of the particular system that is being managed without departing from the scope of the inventive concepts.

As illustrated in FIG. 3, the ML model(s) 306 may be trained using feedback from the system. It has been found that a ML model may be adequately trained using performance data collected over one month at 15 minute intervals. Once the ML model(s) 306 have been adequately trained, a final prediction 308 is generated that labels a cell as predicted to be degraded or non-degraded in the future.

In some embodiments, the decision to label a cell as degraded or non-degraded may be based on both primary and secondary KPI data, where “primary KPI data” refers to the KPI that is being predicted, i.e., UL throughput degradation, and “secondary KPI data” refers to KPIs that contribute to the value of the primary KPI. That is, the labeling of a cell as predictively degraded or non-degraded in terms of UL throughput may be based on more than just a prediction of UL throughput at the target time.

For example, brief reference is made to FIG. 4, which shows a cell labelling operation according to some embodiments based on exploratory data analysis (EDA) results for the 10^{th} percentile and 90^{th} percentile values for throughput, Symbol Utilization and RSSI KPIs, respectively.

In general, data analysis involves finding trends in data through statistics and probability. EDA is a well-known step in data science that involves studying attributes of data, performing outlier analysis, examining missing values, analyzing correlations, etc.

In particular, after an input feature list is obtained (block 402) and processed using an ensemble model (block 404), predicted values of the relevant KPIs are obtained. Separately, EDA is performed at block 408 on historical data collected from the network 300 and analyzed to obtain statistical metrics for the data, such as 10^{th} and 90^{th} percentile values associated with the data. A determination of whether a cell is predicted to be degraded or non-degraded may be obtained by comparing various of the KPIs to 10^{th} and/or 90^{th} percentile values associated with the KPIs. For example, at block 410, the system/method checks to see if the UI, throughput (KPI_throughput) predicted by the ensemble model 404 for a cell is less than the 10^{th} percentile for UL throughput. If so, the system/method checks at block 412 to see if the predicted symbol utilization KPI (KPI_SMBL_UTIL) for the cell is less than the 10^{th} percentile for the KPI. If so, the system/method then checks at block 414 to see if the predicted KPI for received signal strength indicator (KPI_RSSI) for the cell is less than the 90^{th} percentile RSSI. If so, the cell is labeled as degraded at block 418. Otherwise, if any of the above tests was negative, the cell is labeled as non-degraded at block 416.

Referring again to FIG. 3, once a prediction of future cell degradation is generated and a cell has been predictively labeled as degraded, the systems/methods perform root cause identification at block 310 to determine the root cause of the predicted UL degradation. That is, the root cause identification 310 attempts to determine which of the KPIs analyzed was most important to the prediction of UL throughput degradation. By determining which KPI was most important to the prediction, insight may be gained into the cause of the predicted UL throughput degradation. This insight then informs the selection of actuations that may be applied to the network 300 in an effort to avert the predicted degradation in UL throughput.

The root cause identification process may determine that a KPI was an important cause of the predicted throughput degradation is based on whether the KPI demonstrates abnormal behavior, such as by having a value that is far above or below a normal range for the KPI. To that end, a tree SHAP (Shapley Additive explanations) algorithm may be used to find the root cause KPI. In the tree SHAP algorithm, KPIs that were used as inputs to the ML ensemble model may be ranked by importance, and a subset of KPIs representing those determined to be most important to the prediction of UL throughput degradation may be selected as candidate root causes.

The technique used in identifying the important features that led to the prediction of UL throughput degradation may be based on the probability by which each ML model produced an outcome. That is, from among the ML models deployed in the ensemble model, the model with the highest probability of producing the target classification may be chosen, and future analysis conducted in the features that are input to that model.

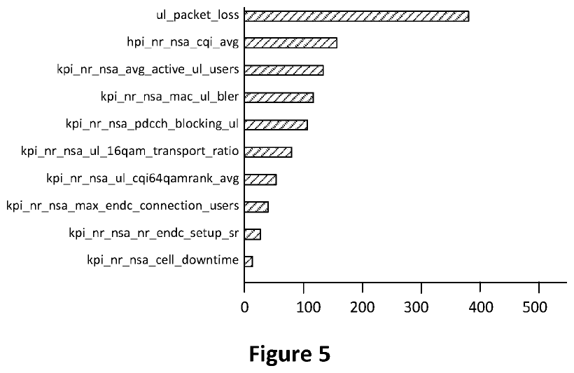

Brief reference is made to FIG. 5, which illustrates an example of a ranking of KPIs that may be output by a root cause mapping operation according to some embodiments based on KPIs input to a LightGBM model. In the example shown in FIG. 5, the ranked KPIs include KPIs relating to packet loss (ul_packet_loss), average channel quality indicator (hpi_nr_nsa_cqi_avg), number of active UL users (kpi_nr_nsa_avg_active_ul_users), uplink block error rate (kpi_nr_nsa_mac_ul_bler), PDCCH blocking ratio (kpi_nr_nsa_pdcch_blocking_ul), transport ratio (kpi_nr_nsa_ul_16qam_transport_ratio), average rank (kpi_nr_nsa_ul_cqi64qamrank_avg), number of connection users (kpi_nr_nsa_max_endc_connection_users), setup scheduling requests (kpi_nr_nsa_nr_endc_setup_sr) and cell downtime (kpi_nr_nsa_cell_downtime). From these KPIs, a subset (e.g., the top five) may be chosen as the most likely candidate causes of the prediction. It will be appreciated that many other KPIs may be considered in the root cause mapping operation.

Referring again to FIG. 3, the subset of KPIs identified as candidate root causes in the root cause identification operation are then provided to a recommendation engine/actuation selection block 312 that generates a recommended actuation to be applied to network 300 to avert the predicted UL throughput degradation based on the identified root causes. In particular, a recommended actuation may be selected by considering the correlation of secondary KPIs, such as CQI, RSSI, packet loss, path loss, etc., with UL throughput degradation. In particular embodiments, the systems/methods may select an actuation based on a consideration of whether a particular type of KPI is considered to be a root cause factor. In determining a recommended actuation, the recommendation engine 312 may consider factors, such as a confidence score of each prediction, a consecutive count of predictions, and business rules.

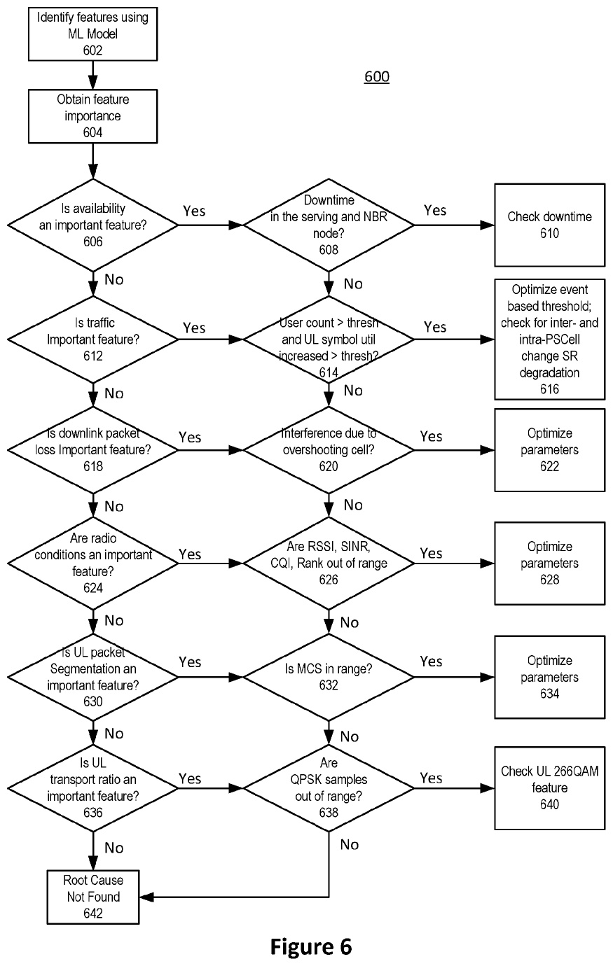

FIG. 6 illustrates an example operation of actuation selection based on a root cause identification operation according to some embodiments. Recommendations for actuations, such as parameter tuning, may be developed with input from subject matter experts. Some example actuations may include modifying event-based thresholds (e.g., handover thresholds), offset tuning, such as cell individual offset (CIO) tuning, traffic balancing, remote electrical tilt (RET) changes, power changes, RRC connected user license expansion, enabling of the UL-256 QAM feature, etc.

As shown in FIG. 6, features associated with the ML model with the highest prediction confidence are identified at block 602. The identified features are then ranked at block 604, for example using a tree SHAP algorithm as described above.

The identified features may then be classified according to type. For example, features may be classified into a category such as alarms, cell downtime, traffic, radio conditions, DL packet loss, retainability, DL transport ratio, new parameter changes, NR capacity in DSS, PDCCH limitations, UL packet segmentation, core network issues, etc.

At block 606, the systems/methods determine whether an important feature is categorized as an availability feature. If so, the systems/methods check to see if there is downtime in a serving or neighboring (NBR) node (block 608), and if so, generates a recommended actuation of checking the downtime in the node (block 610). If not, operations proceed to block 614 below.

Otherwise, at block 612, the systems/methods determine whether an important feature is categorized as a traffic feature. If so, the systems/methods check to see whether the user count is above a threshold and UL symbol utilization is above a threshold (block 614), and if so, generates a recommended actuation of optimizing an event-based threshold and checking for inter- and intra-PSCell change scheduling request (SR) degradation (block 616). If not, operations proceed to block 620 below.

Otherwise, at block 618, the systems/methods determine whether an important feature is categorized as a downlink packet loss feature. If so, the systems/methods check to see whether there is interference due to an overshooting cell (block 620), and if so, generates a recommended actuation of optimizing cell parameters to avoid the overshoot (block 622). If not, operations proceed to block 626 below.

Otherwise, at block 624, the systems/methods determine whether an important feature is categorized as a radio conditions feature. If so, the systems/methods check to see whether a KPI such as RSSI, SINR, CQI, or rank is out of optimal range (block 626), and if so, generates a recommended actuation of optimizing cell parameters to correct the KPI (block 628). If not, operations proceed to block 632 below.

Otherwise, at block 630, the systems/methods determine whether an important feature is categorized as a UL packet segmentation feature. If so, the systems/methods check to see whether the modulation and coding scheme (MCS) is out of range (block 632), and if so, generates a recommended actuation of optimizing cell parameters to correct the MCS (block 634). If not, operations proceed to block 638 below.

Otherwise, at block 636, the systems/methods determine whether an important feature is categorized as a UL transport ratio feature. If so, the systems/methods check to see whether QPSK samples are out of optimal range (block 638), and if so, generates a recommended actuation of checking the UL 256QAM feature (block 640).

If not, then it is determined at block 642 that no root cause can be identified.

Referring again to FIG. 3, the selected actuation is applied to the network 300 at block 314 in an effort to avert the predicted degradation of UL throughput. The systems/methods may continue to monitor the KPIs to ensure that the cell in question is healed, i.e., that it is no longer predicted to suffer UL throughput degradation.

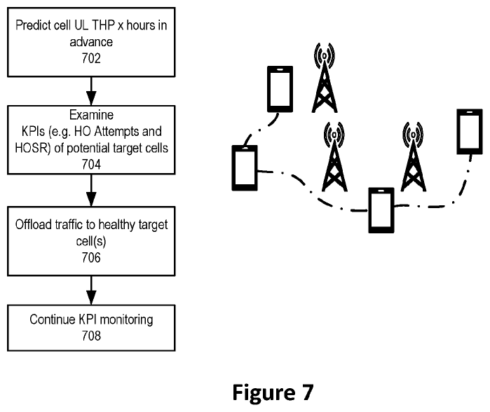

FIG. 7 illustrates self-healing operations according to some embodiments. As shown therein, a system/method according to some embodiments may predict a cell UL throughput x hours in advance (block 702). In response to a predicted drop in throughput in a cell, the systems/methods may cause the cell to handover one or more user equipment connections from to a candidate cell to avoid the predicted degradation. To accomplish this, the system/method may identify a healthy target cell based on KPIs such as handover (HO) attempts, and HO success ratio (HOSR) of one or more candidate target cells (block 704). Once a target cell is identified, traffic is handed over to the target cell (block 706), and, after handover, the systems/methods continue to monitor KPIs in both the source cell and the target cell to predict future UL throughput degradation (block 708).

Accordingly, some embodiments provide operations that may be particularly suitable for managing the operation of a 5G network. According to some embodiments. UL throughput degradation may be predicted, and pre-emptive action may be taken in response to the prediction to mitigate potential performance issues.

Although described herein primarily with reference to 5G networks, some embodiments described herein can be used for other types of wireless communication networks, such as 4G/long term evolution (LTE). Moreover, some embodiments described herein may be applicable for both 5G frequency bands FR1 (Sub-6 GHZ) and FR2 (mmWave).

According to some embodiments, a cell in a wireless communication network is categorized to be in one of a number of modes of operation, including pure LTE, ENDC-LTE, ENDC-NR, or spectrum sharing in NSA. The same approach can be extended to include CA (carrier aggregation) cells in each of LTE/NR as well. Multiple KPIs may be considered in proactive (or reactive) models to obtain a holistic viewpoint of UL degradation. Moreover, sustained degradation may be considered in both modeling and actuation.

Some embodiments enable detection of degraded cells in advance (e.g., as much as two hours in advance), which allows an operator to take precautionary actions to improve network performance.

According to some embodiments, degraded secondary KPIs may be identified, and the degradation of secondary KPIs may be used in the prediction of degradation of a primary KPI, such as UL, throughput degradation. Some embodiments enable self-healing of the network by tuning cell parameters proactively to avoid predicted cell degradation.

Embodiments described herein may provide certain technical advantages. For example, proactive identification and resolution of UL throughput issues may increase the performance of cells by increasing/balancing the utilization of network resources. This may in turn improve the customer experience for applications requiring high UL throughput, such as video conferencing, video gaming, virtual reality, and others.

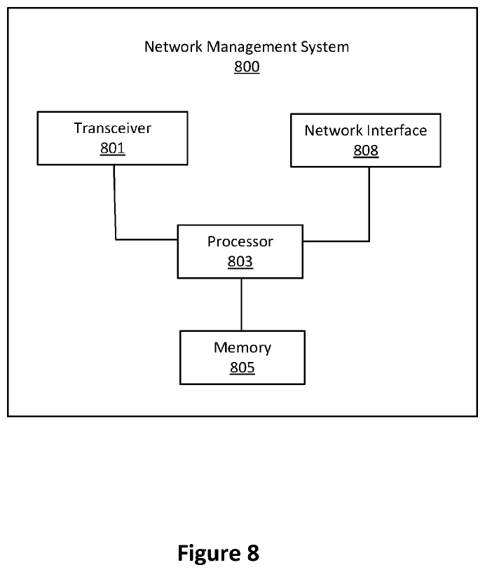

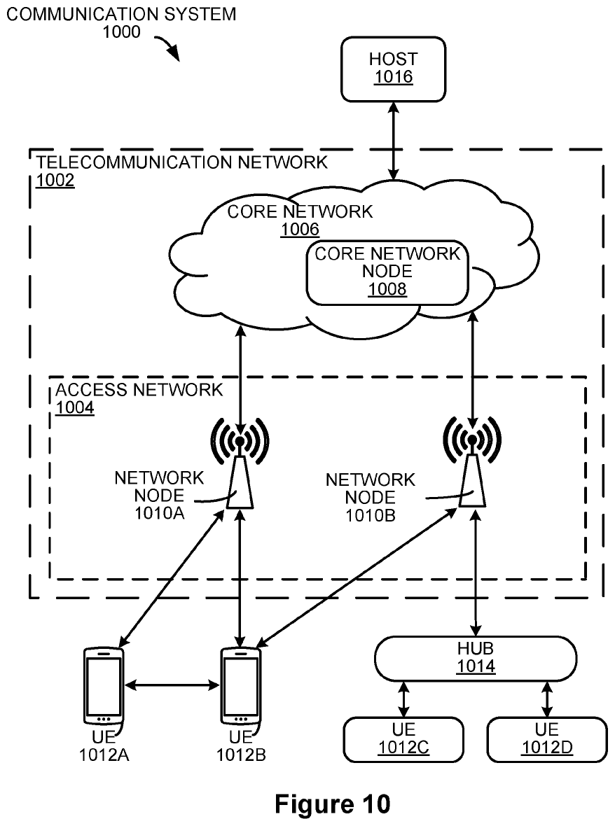

FIG. 8 is a block diagram illustrating elements of a device 800 for managing a wireless communication network according to some embodiments. Device 800 may be provided by, e.g., a device in the cloud running software on cloud computing hardware; or a software function/service governing or controlling a wireless communication network. That is, the device may be implemented as part of a communications system (e.g., a device that is part of the communications system 1000 as discussed below with respect to FIG. 10), or on a device as a separate functionality/service hosted in the cloud. The device also may be provided as a standalone software for managing a wireless communication network; and the device may be in a deployment that may include virtual or cloud-based network functions (VNFs or CNFs) and even physical network functions (PNFs). The cloud may be public, private (e.g., on premises or hosted), or hybrid.

As shown, the device may include transceiver circuitry 800 (e.g., RF transceiver circuitry) including a transmitter and a receiver configured to provide uplink and downlink radio communications with devices (e.g., a controller for automatic execution of actuations). The device may include network interface circuitry 808 (also referred to as a network interface.) configured to provide communications with other devices (e.g., a controller for automatic execution of an actuation). The device may also include processing circuitry 803 (also referred to as a processor) coupled to the transceiver circuitry, memory circuitry 805 (also referred to as memory) coupled to the processing circuitry.

As discussed herein, operations of the device may be performed by processing circuitry 803, network interface 808, and/or transceiver 801. For example, processing circuitry 803 may control the device 800 to perform operations according to embodiments disclosed herein. Processing circuitry 803 also may control transceiver 801 to transmit downlink communications through transceiver 801 over a radio interface to one or more devices and/or to receive uplink communications through transceiver 801 from one or more devices over a radio interface. Similarly, processing circuitry 803 may control network interface 808 to transmit communications through network interface 808 to one or more devices and/or to receive communications through network interface from one or more devices. Moreover, modules may be stored in memory 805, and these modules may provide instructions so that when instructions of a module are executed by processing circuitry 803, processing circuitry 803 performs respective operations (e.g., operations discussed below with respect to example embodiments relating to devices). According to some embodiments, device 800 and/or an element(s)/function(s) thereof may be embodied as a virtual device/devices and/or a virtual machine/machines.

According to some other embodiments, a device may be implemented without a transceiver. In such embodiments, transmission to a wireless device may be initiated by the device 800 so that transmission to the wireless device is provided through a device including a transceiver (e.g., through a base station). According to embodiments where the device includes a transceiver, initiating transmission may include transmitting through the transceiver.

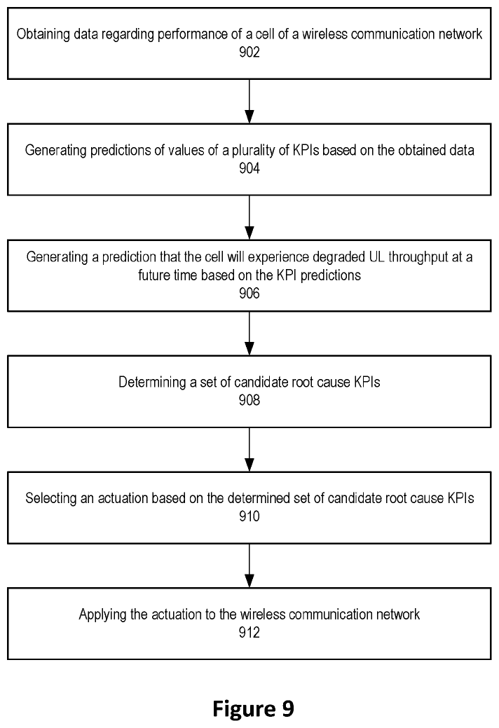

FIG. 9 is a flowchart illustrating a computer-implemented method of a network management system according to some embodiments. Referring to FIG. 9, a method of managing a wireless communication network includes obtaining (block 902) data regarding performance of a cell of the wireless communication network, and generating (block 904), based on the obtained data, predictions of values of a plurality of KPIs of the cell of the wireless communication network that are correlated with UL throughput. The method generates (block 906) a prediction that the cell will experience degraded UL throughput at a future time based on the predicted values of the KPIs, and determines (block 908), from among the plurality of KPIs, a set of candidate root cause KPIs. The method selects (block 910) an actuation based on the determined set of candidate KPIs, and applies (block 912) the actuation to the wireless communication network.

In some embodiments, the data regarding performance of the cell includes performance measurement data and/or configuration management data.

In some embodiments, predicting the value of the KPIs includes generating features for a ML model based on the data regarding performance of the cell.

In some embodiments, generating the features includes generating moving averages of the KPIs over one or more past time periods. Generating the features may include generating lagged values of the KPIs from past time periods.

The method may further include generating threshold values for the KPIs based on historical values of the KPIs, wherein generating the prediction that the cell will experience degraded uplink throughput is based on a comparison of predicted values of the KPIs with the threshold values of the KPIs. The threshold values for the KPIs may be obtained through exploratory data analysis of historical data from the wireless communication network.

In some embodiments, the threshold values of the KPIs may be obtained based on an operating frequency band and bandwidth of the wireless communication system.

The method may further include categorizing the KPIs into a plurality of KPI categories, selecting the ML model from among a plurality of ML models based on the categorization of at least one of the KPIs, and applying the ML model to generate the prediction of the value of the at least one of the KPIs.

In some embodiments, the method may further include selecting a plurality of ML models based on the categorizations of the KPIs, and applying the plurality of ML models.

The KPIs may be categorized as relating to availability, accessibility, retainability, mobility, coverage, quality, utilization, transport ratio and/or accessibility of the cell.

The ML model may include a plurality of ML models, and the prediction that the cell will experience degraded UL throughput may be based on the output of the plurality of models. In particular, the prediction that the cell will experience degraded UL throughput may be based on a weighted average of the output of the plurality of models.

The plurality of ML models may include one or more of an XGBoost model, a CatBoost model, a Random Forest model, a long short-term memory model, and a light gradient boosting model.

In some embodiments, determining the set of candidate root cause KPIs includes generating a ranking of the plurality of KPIs based on importance to the predicted UL throughput degradation, and selecting the set of candidate root cause KPIs based on the ranking of KPIs by importance.

The ranking of the plurality of KPIs may be generated by applying a Tree Shapley Additive Explanations (Tree SHAP) algorithm to the KPI and UL throughput degradation predictions.

The method may further include categorizing each candidate root cause KPI of the set of candidate root cause KPIs into one of a plurality of KPI categories, and the actuation may be selected based on KPI categories of the set of candidate root cause KPIs.

Selecting the actuation may include determining if at least one of the set of candidate root cause KPIs are categorized according a first KPI category. Upon determining that at least one of the set of candidate root cause KPIs is categorized according the first KPI category, the method may check an operating condition of the wireless communication network associated with the first KPI category, and select the actuation based on the operating condition of the wireless communication network associated with the first KPI category.

The method may further include repeating, for a plurality of KPI categories, steps of determining if at least one of the set of candidate root cause KPIs are categorized according a KPI category, checking an operating condition of the wireless communication network associated with the KPI category, and selecting the actuation based on the operating condition of the wireless communication network associated with the KPI category.

Some embodiments provide a network management system (800) including a processor (803), and a memory (805) coupled to the processor, wherein the memory includes computer program instructions that, when executed by the processor, cause the network control device to perform operations illustrated in FIG. 9.

Some embodiments provide a computer program including computer code to be executed by a network management system (800) configured to perform operations illustrated in FIG. 9.

Some embodiments provide a computer program product including a non-transitory storage medium (805) including program code to be executed by processing circuitry (803) of a network management system (800), whereby execution of the program code causes the device to perform operations illustrated in FIG. 9.

FIG. 10 shows an example of a communication system 900 in accordance with some embodiments.

In the example, the communication system 1000 includes a telecommunication network 1002 that includes an access network 1004, such as a RAN, and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of a user equipment (UE), such as by connecting UEs 1012a, 1012b. 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC). Mobility Management Entity (MME). Home Subscriber Server (HSS). Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, hosts, and devices. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave. Near Field Communication (NFC) ZigBee. LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (cMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b).

Although the devices described herein may include the illustrated combination of hardware components, other embodiments may comprise computing devices with different combinations of components. It is to be understood that these devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the device, and/or performing one or more operations based on the obtained information or converted information, and as a result of said processing making a determination. Moreover, while components are depicted as single boxes located within a larger box, or nested within multiple boxes, in practice, devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the device, but are enjoyed by the device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”. “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of managing a wireless communication network, comprising:
obtaining data regarding performance of a cell of the wireless communication network;
generating, based on the obtained data, predictions of values of a plurality of key performance indicators (KPIs) of the cell of the wireless communication network that are correlated with uplink (UL) throughput;
generating a prediction that the cell will experience degraded UL throughput at a future time based on the predicted values of the KPIs;
determining, from among the plurality of KPIs, a set of candidate root cause KPIs associated with the predicted degraded UL throughput;
selecting an actuation based on the determined set of candidate KPIs; and
applying the actuation to the wireless communication network.

2. The method of claim 1, wherein the data regarding performance of the cell comprises performance measurement data and/or configuration management data.

3. The method of claim 1, wherein predicting the value of the KPIs comprises generating features for a machine learning (ML) model based on the data regarding performance of the cell.

4. The method of claim 3, wherein generating the features comprises generating moving averages of the KPIs over one or more past time periods.

5. The method of claim 3, generating the features comprises generating lagged values of the KPIs from past time periods.

6. The method of claim 3, further comprising:
generating threshold values for the KPIs based on historical values of the KPIs, wherein generating the prediction that the cell will experience degraded uplink throughput is based on a comparison of predicted values of the KPIs with the threshold values of the KPIs.

7. The method of claim 6, wherein the threshold values for the KPIs are obtained through exploratory data analysis of historical data from the wireless communication network.

8. The method claim 6, wherein the threshold values of the KPIs are obtained based on an operating frequency band and bandwidth of the wireless communication network.

9. The method of claim 3, further comprising:
categorizing the KPIs into a plurality of KPI categories;
selecting the ML model from among a plurality of ML models based on the categorization of at least one of the KPIs; and
applying the ML model to generate the prediction of the value of the at least one of the KPIs.

10. The method of claim 9, further comprising:
selecting a plurality of ML models based on the categorizations of the KPIs; and
applying the plurality of ML models.

11. (canceled)

12. The method of claim 3, wherein the ML model comprises a plurality of ML models, and the prediction that the cell will experience degraded UL throughput is based on the output of the plurality of models.

13. The method of claim 12, wherein the prediction that the cell will experience degraded UL throughput is based on a weighted average of the output of the plurality of models.

14. The method of claim 10, wherein the plurality of ML models comprises one or more of an XGBoost model, a Random Forest model, a long short-term memory model, a CatBoost model, and a light gradient boosting model.

15. The method of claim 1, wherein determining the set of candidate root cause KPIs comprises:
generating a ranking of the plurality of KPIs based on importance to the predicted UL throughput degradation; and
selecting the set of candidate root cause KPIs based on the ranking of KPIs by importance.

16. The method of claim 15, wherein the ranking of the plurality of KPIs is generated by applying a Tree Shapley Additive Explanations (Tree SHAP) algorithm to the KPI and UL throughput degradation predictions.

17. The method of claim 1, further comprising:
categorizing each candidate root cause KPI of the set of candidate root cause KPIs into one of a plurality of KPI categories;
wherein the actuation is selected based on KPI categories of the set of candidate root cause KPIs.

18. The method of claim 17, wherein selecting the actuation comprises:
determining if at least one of the set of candidate root cause KPIs are categorized according to a first KPI category;
upon determining that at least one of the set of candidate root cause KPIs is categorized according to the first KPI category, checking an operating condition of the wireless communication network associated with the first KPI category; and
selecting the actuation based on the operating condition of the wireless communication network associated with the first KPI category.

19. The method of claim 18, further comprising repeating, for a plurality of KPI categories, steps of determining if at least one of the set of candidate root cause KPIs are categorized according to a KPI category, checking an operating condition of the wireless communication network associated with the KPI category, and selecting the actuation based on the operating condition of the wireless communication network associated with the KPI category.

20. A network management system comprising:
a processor; and
a memory coupled to the processor;
wherein the memory comprises computer program instructions that, when executed by the processor, cause the network management system to perform operations according to claim 1.

21. (canceled)

22. A computer program product comprising a non-transitory storage medium including program code to be executed by processing circuitry of a network management system, whereby execution of the program code causes the device to perform operations according to claim 1.
